(19) United States
(12) Patent Application Publication
(10) Pub. No.: US 2010/0096572 A1
(43) Pub. Date: Apr. 22, 2010

(54) Air Valve

(76) Inventor: Ming Teng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,898

(22) Filed: Oct. 16, 2008

(51) Int. Cl. F16K 35/00; F16K 31/50

(52) U.S. Cl. 251/93; 251/264

(57) ABSTRACT

An air valve includes a tubular seat, a cap, and a plug. The tubular seat has an outer circumferential surface forming sealing slots, first external thread and second external thread and also forms an axially-extending air passage. The cap has an inside circumferential surface forming first internal thread, second internal thread, and a barrier web. The barrier web forms a bore and a plurality of air holes. The cap has a distal open end to which a lid is mounted. The plug has an expanded proximal end to which a sealing pad is attached and a reduced section slidably received in the bore of the barrier web and having a distal end to which a stop is mounted so that the plug is axially movable with respect to the barrier web. The cap is screwed onto the tubular seat and is selectively set at different axial locations so that the sealing pad is selectively set in engagement with or disengagement from the air passage to selectively set the air valve in a primary closing condition, where sealing is ensured and leaking of air is prevented, an open condition, where air is allow to freely flow into and out of the air valve, and an air releasing condition, where air is only allowed to flow out of the air valve.

### BACKGROUND OF THE INVENTION

1. Field of the Invention

The present invention relates to an air valve, and in particular to an air valve comprised of an assembly of a tubular seat, a cap, and a plug whereby by rotating and thus adjusting the location of the cap with respect to the tubular seat to which the cap is screwed, three operation modes of (1) ensuring sealing and preventing air leaking, (2) allowing both inflow and outflow of air, and (3) one-way air releasing can be selectively actuated.

2. The Related Arts

Conventional air valves are often installed in an inflatable/deflatable article, such as an inflatable mattress and an inflatable toy. The conventional structure of the air valve comprises an air inlet in which a valve member that openably seals the air inlet and/or is manually operable to disengage from and thus open the air inlet. When an inflated pressure becomes greater than the outside pressure, the valve member automatically closes the air inlet to ensure air-tight sealing or alternatively, the valve member is controllable to selectively open the air inlet for inflation/deflection.

The known air valves are effective in providing air-tight sealing after the inflation operation to prevent air from leaking out of the inflated article. However, the known air valves are still of certain drawbacks. For example, in deflecting the inflated article by releasing air from the inflated article, there is always a substantial residual of air remaining within the deflected article, making the article only partially deflated, and further deflection to reduce the overall deflated size of the article to the minimum is generally very difficult, if not impossible. This is adverse to storage and transportation of the deflected article. One way to handle this situation is to forcibly depress or squeeze the partially deflected article to expel the residual air out of the deflected article. However, squeezing or depressing the partially deflected article increases inside pressures of the article to be greater than the outside pressure and such a pressure difference causes the conventional air valve to close, thereby preventing further expelling air out of the article. For an individual encountering such a situation, one of his or her hands must be operating the air valve to maintain opening of the valve and use the remaining hand to squeeze or depress the article. This is certainly very difficult or troublesome.

### SUMMARY OF THE INVENTION

Thus, the present invention is aimed to provide an air valve that overcomes the above discussed deficiencies.

In other words, an objective of the present invention is to provide an air valve that is comprised of a tubular seat, a cap, and a plug, wherein the cap is screwed on the tubular seat and is selectively set at different axial locations to selectively set the air valve in a primary closing condition, where sealing is ensured and leaking of air is prevented, an open condition, where air is allow to freely flow into and out of the air valve, and an air releasing condition, where air is only allowed to flow out of the air valve.

To achieve the above objective, a technique solution in accordance with the present invention is as follows.

The present invention provides an air valve that is comprised of a tubular seat, a cap, and a plug.

The tubular seat has an outer circumferential surface forming sealing slots, first external thread and second external thread. The tubular seat also forms an axially-extending air passage.

The cap forms an internal space delimited by an inside surface forming first internal thread, second internal thread, and a barrier web. The barrier web forms a bore and a plurality of air holes. The cap has a distal open end to which a lid is mounted.

The plug is arranged inside the internal space of the cap and has an expanded proximal end to which a sealing pad is attached and a reduced section slidably received in the bore of the barrier web. The reduced section has a distal end to which a stop is mounted. Thus, the plug is axially movable with respect to the barrier web.

The tubular seat is adapted to mount to an inflatable body by the sealing slots.

The cap is screwed on the tubular seat to have the plug located corresponding to the air passage of the tubular seat.

By rotating the cap to set the cap at different axial directions with respect to the tubular seat, the plug is set at different positions with respect to the air passage so that the sealing pad is selectively set in engagement with or disengagement from the air passage to selectively set the air valve in a primary closing condition, where air is not allow to flow in and out of the air valve and sealing is ensured and leaking of air is prevented, an open condition, where air is allow to freely flow into and out of the air valve, and an air releasing condition, where air is only allowed to flow out of the air valve.

In accordance with the present invention, by rotation of the cap to set the plug at different positions, the following functions can be respectively realized:

(1) Function of ensuring sealing and preventing leaking: When an inflatable body is inflated to a desired extent, the cap is rotated and tightened on the tubular seat have the sealing pad of the plug engaging the air passage of the tubular seat to seal air inside the inflatable body and thus realizing sealing and leaking securing.

(2) Function of one way air releasing: The cap is rotated to a position disengaging from both external threads, making the sealing pad spaced from the air passage of the tubular seat and slidable with respect to the barrier web of the cap, so that when the inflatable body is subjected to an external force to expel air therefrom, inside pressure of the inflatable body, which becomes greater than outside pressure, drives away the plug to allow outflow of air, and when the external force is removed, the inside pressure of the inflatable body becomes less than the outside pressure and the outside pressure moves the plug to have the sealing pad abutting against and thus closing the air passage and thus blocking inflow of air thereby realizing the function of one way air releasing. This allows the inflatable to be squeezed to the minimum deflected volume.

(3) Function of allow both inflow and outflow: The cap is rotated to move to an outmost position with respect to the tubular seat so that the sealing pad of the plug is located furthest from the air passage to allow both inflow and outflow of air. This function allows for inflation and/or deflection of the inflatable body.

The inflatable body as used here in the present invention can be various inflatable articles, and examples include an inflatable mattress, an inflatable toy and an inflatable/deflatable air bag.

### BRIEF DESCRIPTION OF THE DRAWINGS

The present invention will be apparent to those skilled in the art by reading the following description of preferred embodiment thereof, with reference to the attached drawings, wherein:

FIG. 1 shows a perspective view of an air valve constructed in accordance with the present invention;

FIG. 2 is an exploded view of the air valve constructed in accordance with the present invention;

FIG. 3 shows a cross-sectional view, in an exploded form, of the air valve constructed in accordance with the present invention;

FIG. 4 shows a cross-sectional view of the air valve of the present invention in an assembled form, wherein the air valve is set in a primary closing condition in which air flow is blocked for both inflow and outflow;

FIG. 5 also shows a cross-sectional view of the air valve but showing the air valve in an open condition, which allows for both inflow and outflow of air into and out of the air valve;

FIG. 6 is another cross-sectional view of the air valve, showing an air releasing condition, wherein only outflow is allowed;

FIG. 7 is a further cross-sectional view of the air valve, illustrating a secondary closing condition, wherein both inflow and outflow are blocked; and

FIG. 8 is a cross-sectional view of an inflatable body to which the air valve of the present invention is mounted.

### DETAILED DESCRIPTION OF THE PREFERRED EMBODIMENT

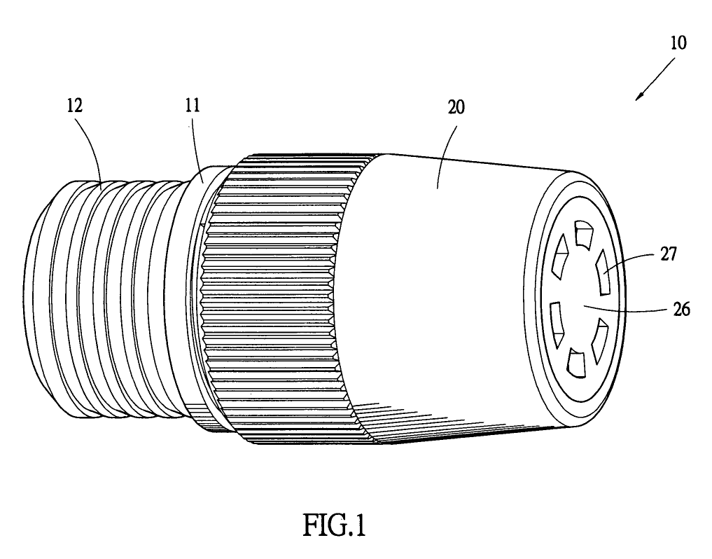

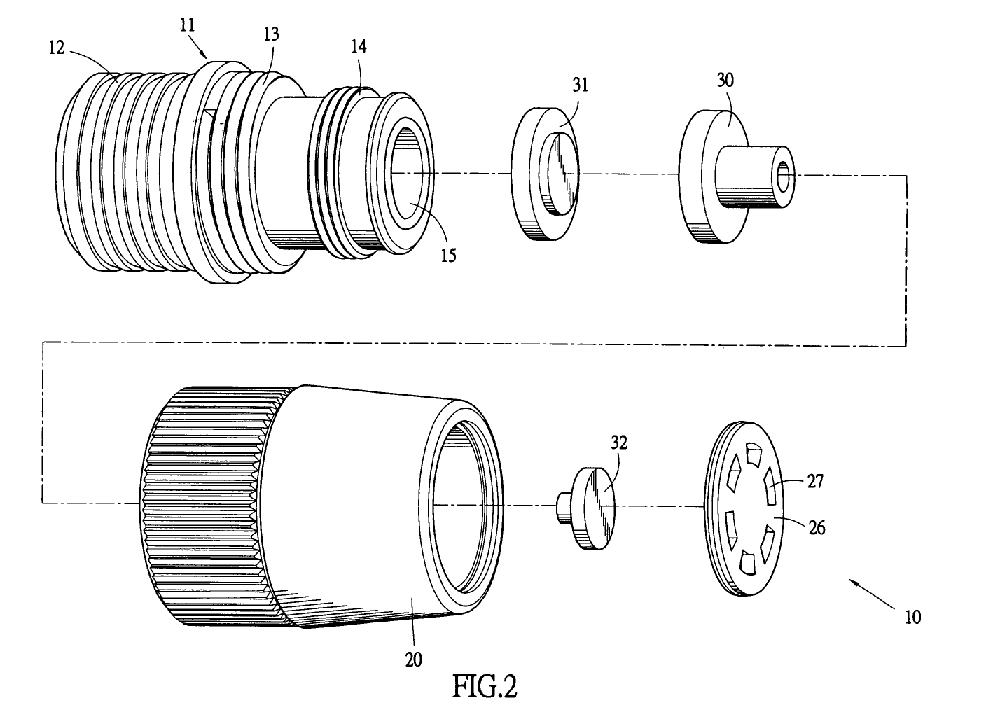

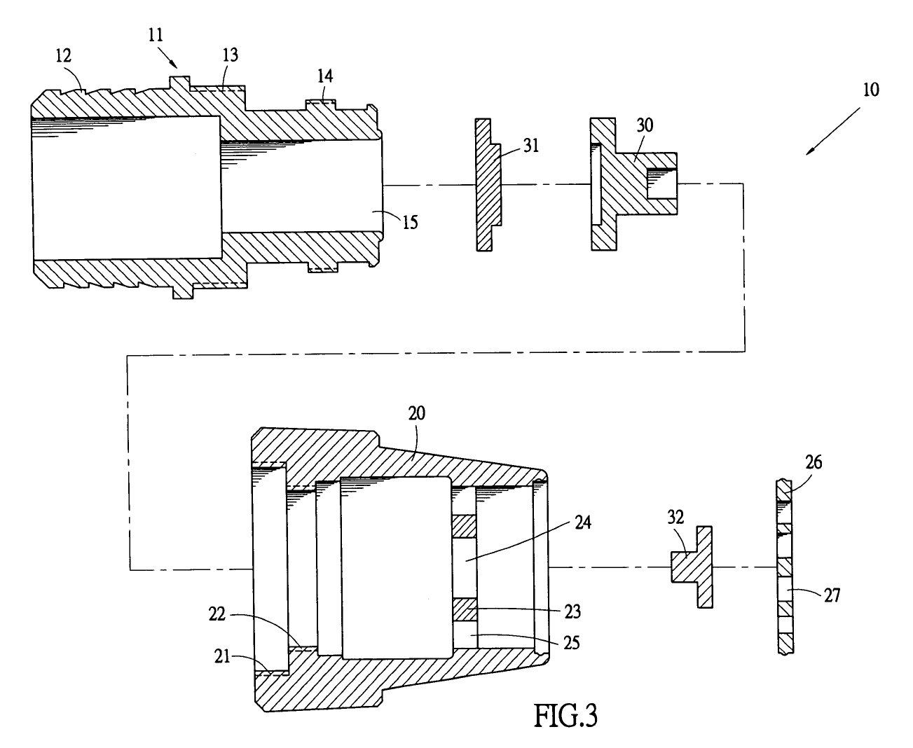

With reference to the drawings and in particular to FIGS. 1-3, which respectively show a perspective view, an exploded view, and a cross-sectional view in exploded form of an air valve constructed in accordance with the present invention, generally designated with reference numeral 10, the air valve 10 comprises tubular seat 11, a cap 20, and a plug 30. As shown in FIGS. 2 and 3, the tubular seat 11 has an outer circumferential surface on which circumferential sealing slots 12, a first external thread section 13, and a second external thread section 14 are formed. The tubular seat 11 is made hollow, forming an axially extending bore serving as an air passage 15.

The cap 20 is also made hollow, forming an interior space delimited by a circumferential inside surface on which a first internal thread section 21, a second internal thread section 22, and a barrier web 23 are formed. The barrier web 23 forms a central bore 24 and a plurality of air holes 25. The hollow cap 20 has a proximal open end and an opposite distal open end. A lid 26 is received in and closes the distal open end. Air holes 27 are defined in the lid 26.

The plug 30 is received in the interior space of the cap 20 and comprises an expanded proximal end to which a resilient pad 31, which can be made of rubber or plastics, is attached and a diameter-reduced section that is snugly fit in the central bore 24 of the barrier web 23, allowing relative sliding therebetween. The diameter-reduced section has a distal end to which a stop 32 is attached. The stop 32 has an expanded diameter so that the plug 30 is prevented from sliding off the barrier web 23 when the plug 30 takes axial sliding motion with respect to the barrier web 23.

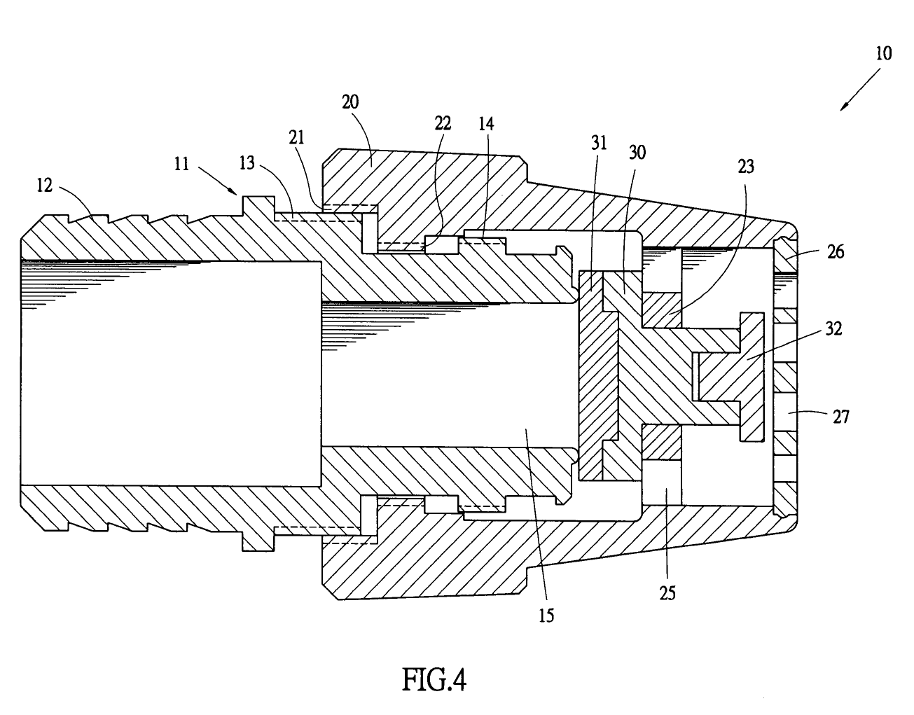

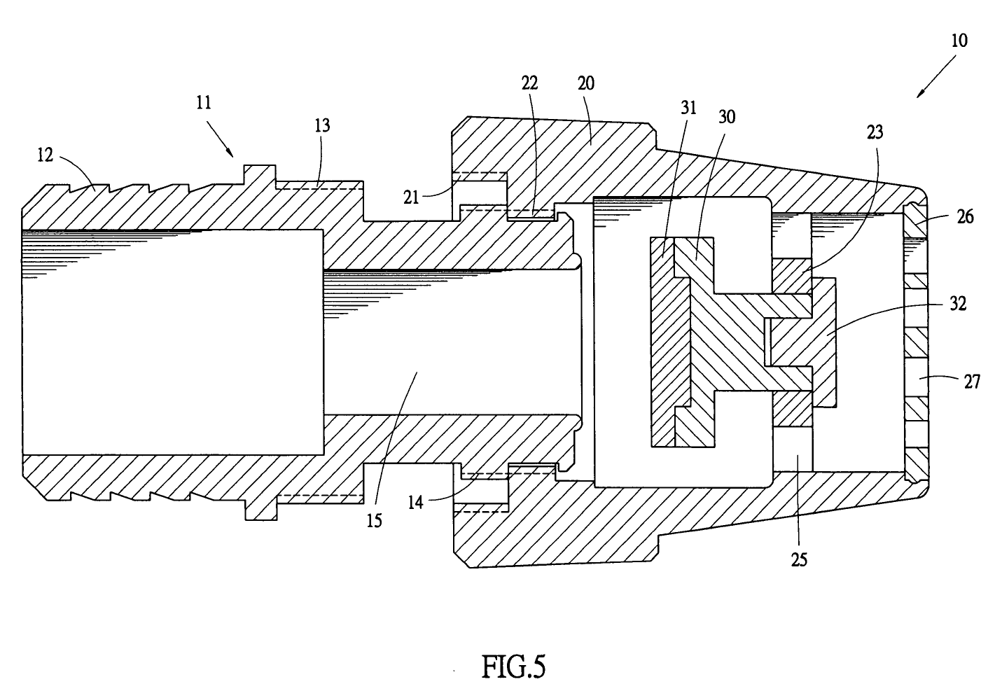

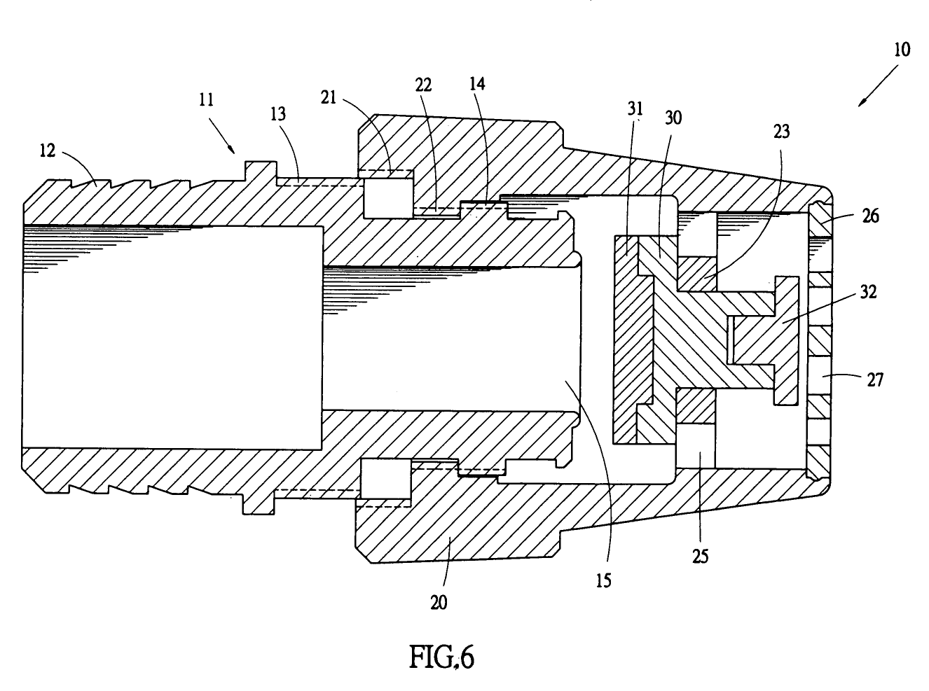

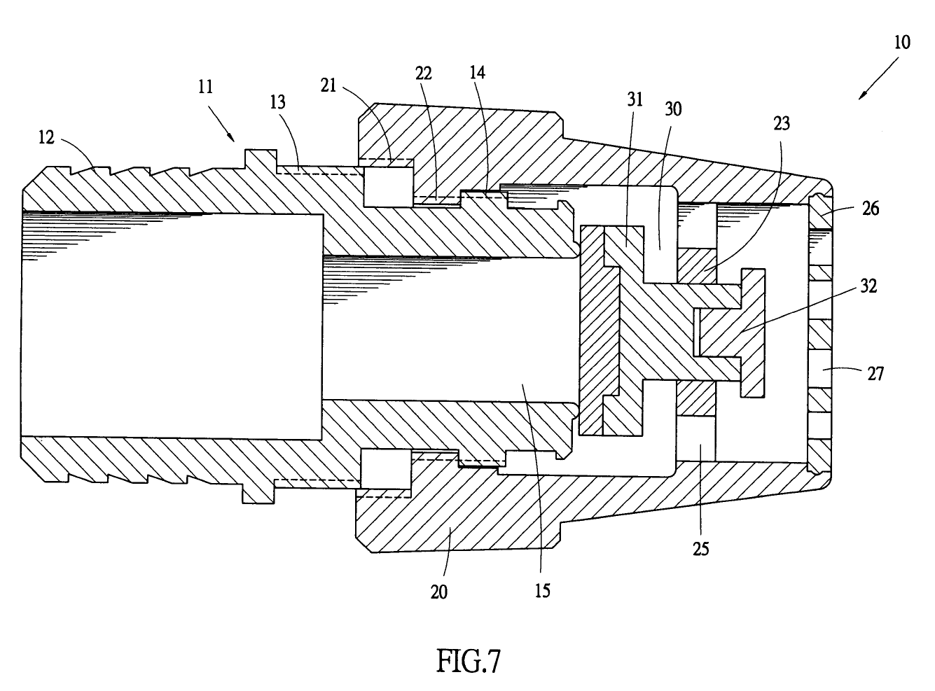

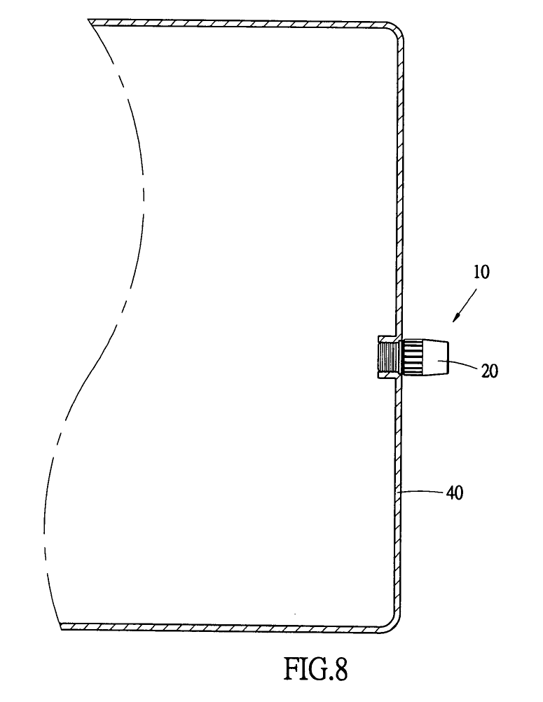

Also referring to FIGS. 4-8, FIG. 4 shows a cross-sectional view of the air valve 10 of the present invention in an assembled form, wherein the air valve is set in a primary closing condition in which air flow is blocked for both inflow and outflow. FIG. 5 also shows a cross-sectional view of the air valve 10, but showing the air valve 10 in an open condition, which allows for both inflow and outflow of air into and out of the air valve 10. FIG. 6 is another cross-sectional view of the air valve 10, showing an air releasing condition, wherein only outflow is allowed. FIG. 7 is a further cross-sectional view of the air valve 10, illustrating a secondary closing condition. FIG. 8 is a cross-sectional view of an inflatable body or device 40 to which the air valve 10 of the present invention is mounted. Examples of the inflatable body 40 include an inflatable mattress, an inflatable toy and an inflatable/deflatable air bag, but not limited thereto.

As shown in FIGS. 1 and 8, the tubular seat 11 of the air valve 10 is mounted to the inflatable body or device 40 by having the sealing slots 12 engaging corresponding portions of the inflatable body or device 40. Also see FIGS. 4 and 5, the cap 20 is mounted to the tubular seat 11 by screwing operation so that the plug 30 is positioned corresponding to the air passage 15 of the tubular seat 11.

By rotating the cap 20 with respect to the tubular seat 11 so as to set the cap 20 at different axial position with respect to the tubular seat 11, the plug 30 that is received in the cap 20 is movable with the cap 20 to set at different position with respect to the tubular seat 11, whereby the resilient pad 31, which serves as a sealing member in the embodiment illustrated, selectively engages or disengages from the air passage 15 of the tubular seat 11, thereby selectively setting the air valves 10 in the primary closing condition, the open condition, and the air releasing condition.

As shown in FIG. 4, when the inflatable boy 40 is inflated to a desired extent, by tightening the cap 20 to have the first internal thread 21 of the cap 20 engaging and moving along the first external thread 13 of the tubular seat 11, the cap 20 is moved and the barrier web 23 drives the plug 30, causing the pad 31 of the plug 30 to abut against and thus close the air passage 15 of the tubular seat 11, thereby sealing air inside the inflatable body.

As shown in FIG. 5, to conduct inflation or deflation of the inflatable body 40, the cap 20 is rotated to move to the outermost location of the tubular seat 11 with the second internal thread 22 of the cap 20 engaging and moving along the second external thread 14 of the tubular seat 11. The barrier web 23 move the plug 30 to set the resilient pad 31 located furthest from the air passage 15 of the tubular seat 11. In this condition, air is allowed to move in and out of the air valve 10 freely, namely both inflow and outflow of air are allowed.

As shown in FIGS. 6 and 7, by rotating the cap 30 in such a way that the second internal thread 22 of the cap 20 is set between the first and second external threads 13, 14 of the tubular seat 11, the resilient pad 31 of the plug 30 is located away from the air passage 15 of the tubular seat 11 and is allowed to axially slide with respect to the barrier web 23. Thus, when the inflatable body 40 is squeezed or depressed to release air therefrom, the internal pressure of the inflatable body 40 caused by the squeezing or depressing drives the plug 30 away to allow air to flow out of the air valve 10 as shown in FIG. 6. When squeezing or depressing the inflatable boy 40 is interrupted, the internal pressure of the inflatable body 40 becomes less than outside pressure, thereby the outside pressure drives the plug 30 inward to have the pad 31 of the plug 30 abutting against and thus closing the air passages 15. Air is thus not allowed to enter the inflatable body 40 through the air valve 10. In this way, one way releasing of air from the inflatable boy 40 can be realized.

The feature of one-way releasing of air allows the inflatable body 40 to be deflated to the minimum volume available, and this facilitates storage and carrying of the inflatable body.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An air valve comprising:
a tubular seat having an outer surface forming sealing slots, first external thread and second external thread, the tubular seat forming an axially-extending air passage, the tubular seat being adapted to mount to an inflatable body by the sealing slots;
a cap forming an internal space delimited by an inside surface forming first internal thread, second internal thread, and a barrier web, the barrier web forming a bore and a plurality of air holes, the cap having a distal open end to which a lid is mounted, the lid forming a plurality of air holes; and
a plug arranged inside the internal space of the cap and having an expanded proximal end to which a sealing pad is attached and a reduced section slidably received in the bore of the barrier web, the reduced section having a distal end to which a stop is mounted so that the plug is axially movable with respect to the barrier web;
wherein the cap is screwed onto the tubular seat to have the plug located corresponding to the air passage of the tubular seat and wherein by rotating the cap to set the cap at different axial directions with respect to the tubular seat, the plug is set at different positions with respect to the air passage so that the sealing pad is selectively set in engagement with or disengagement from the air passage to selectively set the air valve in a primary closing condition, where air is not allow to flow in and out of the air valve and sealing is ensured and leaking of air is prevented, an open condition, where air is allow to freely flow into and out of the air valve, and an air releasing condition, where air is only allowed to flow out of the air valve.

2. The air valve as claimed in claim 1, wherein the cap is rotatable with respect to the tubular seat to have the first internal thread of the cap engaging and moving along the first external thread of the tubular seat thereby causing the barrier web to move the plug to such a position that the sealing pad of the plug engaging the air passage of the tubular seat to seal air inside the inflatable body and thus realizing sealing and leaking securing of the primary closing condition.

3. The air valve as claimed in claim 1, wherein the cap is rotatable to move to an outmost position with respect to the tubular seat with the second internal thread of the cap engaging and moving along the second external thread thereby causing the barrier web to move the plug to such a position that the sealing pad of the plug is located furthest from the air passage to allow both inflow and outflow of air thereby realizing inflation/deflation of the open condition.

4. The air valve as claimed in claim 1, wherein the cap is rotatable to move with respect to the tubular seat to such a position where the second internal thread is substantially located between the first and second external threads of the tubular seat with the sealing pad spaced from the air passage of the tubular seat and slidable with respect to the barrier web of the cap so that when the inflatable body is subjected to an external force to expel air therefrom, inside pressure of the inflatable body, which becomes greater than outside pressure, drives away the plug to allow outflow of air and when the external force is removed, the inside pressure of the inflatable body becomes less than the outside pressure and the outside pressure moves the plug to have the sealing pad abutting against and thus closing the air passage and thus blocking inflow of air thereby realizing the air releasing condition where only one way releasing of air from the inflatable body of the air is allowed.

5. The air valve as claimed in claim 1, wherein the inflatable body comprises an inflatable mattress.

6. The air valve as claimed in claim 1, wherein the inflatable body comprises an inflatable toy.

7. The winch as claimed in claim 1, wherein the inflatable body comprises an inflatable/deflatable air bag.
